(19) United States
(12) Patent Application Publication
(10) Pub. No.: US 2015/0066804 A1
(43) Pub. Date: Mar. 5, 2015

(54) METHOD AND SYSTEM FOR GENERATING A CUSTOMER SURVEY FOR AN IMAGE FORMING APPARATUS

(71) Applicant: KONICA MINOLTA LABORATORY U.S.A., INC., San Mateo, CA (US)

(72) Inventor: Toshiyuki MITSUBORI, San Mateo, CA (US)

(73) Assignee: KONICA MINOLTA LABORATORY U.S.A., INC., San Mateo, CA (US)

(21) Appl. No.: 14/012,157

(22) Filed: Aug. 28, 2013

(51) Int. Cl. G06Q 30/02

(52) U.S. Cl. CPC G06Q 30/0282
USPC 705/347

(57) ABSTRACT

A method and system for generating a customer survey for an image forming apparatus is disclosed, which includes generating an e-mail on the image forming apparatus addressed to one or more customers; forwarding the generated e-mail to the one or more customers, wherein each of the one or more customers is requested to complete a customer satisfaction survey; receiving answers to the customer satisfaction survey from the one or more customers; tabulating the answers to the customer satisfaction survey from the one or more customers to determine if the image forming apparatus has one or more complaints associated therewith; selecting a temporary solution for each of the one or more complaints on the image forming apparatus having a complaint ratio greater than a predetermined ratio; and implementing the temporary solution on the image forming apparatus.

### FIELD

This invention relates to a method and system for generating a customer satisfaction survey for an image forming apparatus.

### BACKGROUND

The performance of image forming apparatuses including multifunctional printers (MFP) can occasionally be at less than desired. For example, the image forming apparatus can run slow including slow print speed, slow scanning speed, and/or slow warm-up speed. In addition, image forming apparatuses can jam at one or more locations, and/or print quality can include different colors from one print copy to another, collapsed images, extremely light colors on one or more sheets, and/or the image forming apparatus can easily run out of toner.

### SUMMARY

In consideration of the above issues, it would be desirable to have an image forming apparatus, which periodically surveys the user's satisfaction of the image forming apparatus and adjusts and/or changes the settings of the image forming apparatus based on answers received from a customer satisfaction survey. In accordance with an exemplary embodiment, the results of the customer satisfaction surveys can be sent to a customer service department associated with the image forming apparatus and/or service vendor for further processing and/or handling.

In accordance with an exemplary embodiment, a method for generating a customer survey for an image forming apparatus is disclosed, comprising: generating an e-mail on the image forming apparatus addressed to one or more customers, each of the one or more customers having sent at least one print job to the image forming apparatus; forwarding the generated e-mail to the one or more customers, wherein each of the one or more customers is requested to complete a customer satisfaction survey; receiving answers to the customer satisfaction survey from the one or more customers; tabulating the answers to the customer satisfaction survey from the one or more customers to determine if the image forming apparatus has one or more complaints associated therewith; selecting a temporary solution for each of the one or more complaints on the image forming apparatus having a complaint ratio greater than a predetermined ratio; and implementing the temporary solution on the image forming apparatus for each of the one or more complaints on the image forming apparatus having the complaint ratio greater than the predetermined ratio.

In accordance with an exemplary embodiment, a computer program product comprising a non-transitory computer readable medium having a computer readable code embodied therein for generating a customer survey for an image forming apparatus is disclosed, the computer readable program code configured to execute a process, which includes the steps of: generating an e-mail on the image forming apparatus addressed to one or more customers, each of the one or more customers having sent at least one print job to the image forming apparatus; forwarding the generated e-mail to the one or more customers, wherein each of the one or more customers is requested to complete a customer satisfaction survey; receiving answers to the customer satisfaction survey from the one or more customers; tabulating the answers to the customer satisfaction survey from the one or more customers to determine if the image forming apparatus has one or more complaints associated therewith; selecting a temporary solution for each of the one or more complaints on the image forming apparatus having a complaint ratio greater than a predetermined ratio; and implementing the temporary solution on the image forming apparatus for each of the one or more complaints on the image forming apparatus having the complaint ratio greater than the predetermined ratio.

In accordance with an exemplary embodiment, an image forming system is disclosed comprising: one or more client devices, which are operable by one or more customers; and an image forming apparatus connected to the one or more client devices, wherein the image forming apparatus perform the following steps: generating an e-mail on the image forming apparatus addressed to the one or more customers, each of the one or more customers having sent at least one print job to the image forming apparatus; forwarding the generated e-mail to the one or more customers, wherein each of the one or more customers is requested to complete a customer satisfaction survey; receiving answers to the customer satisfaction survey from the one or more customers; tabulating the answers to the customer satisfaction survey from the one or more customers to determine if the image forming apparatus has one or more complaints associated therewith; selecting a temporary solution for each of the one or more complaints on the image forming apparatus having a complaint ratio greater than a predetermined ratio; and implementing the temporary solution on the image forming apparatus for each of the one or more complaints on the image forming apparatus having the complaint ratio greater than the predetermined ratio.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an illustration of an image forming system for generating a customer survey for an image forming apparatus in accordance with an exemplary embodiment;

FIG. 2 is an illustration of a customer survey request in the form of an e-mail, which is sent from the image forming apparatus to a user in accordance with an exemplary embodiment;

FIGS. 3A-3D are illustrations of different scenarios for an image forming system in connection with generating a customer survey for an image forming apparatus in accordance with an exemplary embodiment;

FIG. 4 is an illustration of an image forming system for generating a customer survey for an image forming apparatus in accordance with an exemplary embodiment;

FIG. 5 is an illustration of a customer satisfaction survey for an image forming apparatus in accordance with an exemplary embodiment;

FIG. 6 is a flow chart illustrating a process of sending a customer satisfaction survey from an image forming apparatus to one or more users and/or customers in accordance with an exemplary embodiment;

FIG. 7 is a chart illustrating customer and/or user complaints and a corresponding complaint ratio in accordance with an exemplary embodiment;

FIG. 8 is a chart illustrating customer and/or user complaints, temporary solutions of the image forming apparatus, and conflicts against other temporary solutions of the image forming apparatus in accordance with an exemplary embodiment;

FIG. 9 is a chart illustrating customer and/or user complaints and recommendations to a customer service department, if a customer complaint ratio exceeds a predetermined ratio in accordance with an exemplary embodiment; and

FIGS. 10A-10H are an illustration of a chart showing customer complaints, temporary solutions provided by the image forming apparatus, recommendations to a customer service department, conflicts against other temporary solutions of the image forming apparatus, complaint ratio, determination if a temporary solution should be performed or not, and solutions in accordance with an exemplary embodiment.

### DESCRIPTION OF THE PREFERRED EMBODIMENTS

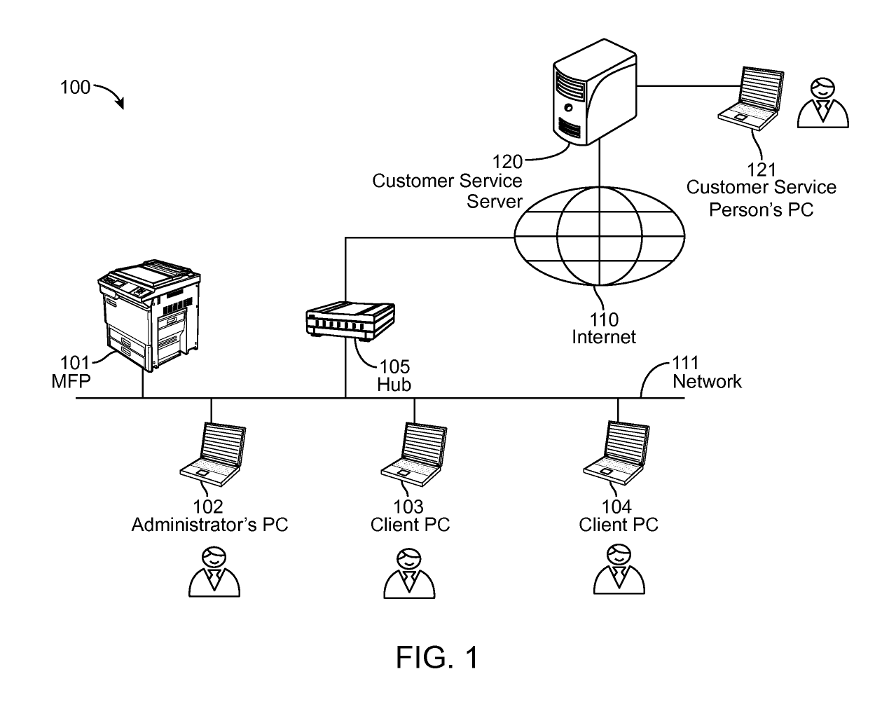

FIG. 1 is an illustration of an image forming system 100 for generating a customer survey for an image forming apparatus in accordance with an exemplary embodiment. As shown in FIG. 1, the system 100 includes an image forming apparatus 101, one or more clients or client devices, 102, 103, 104, one or more routers, networking devices and/or hubs 105, a customer service server 120, and a customer service client device 121. The image forming apparatus 101, the one or more clients 102, 103, 104, the one or more routers, networking devices and/or hubs 105, the customer service server 120, and the customer service device 121 can be connected via an Internet or network connection 110, 111, such as a LAN (Local Area Network) or WAN (Wide Area Network).

In accordance with an exemplary embodiment, each of the one or more client devices 102, 103, 104 includes a processor or central processing unit (CPU), and one or more memories for storing software programs and data (such as files to be printed). The processor or CPU carries out the instructions of a computer program, which operates and/or controls at least a portion of the functionality of the client devices 102, 103, 104. Each of the client devices 102, 103, 104, also includes an operating system (OS), which manages the computer hardware and provides common services for efficient execution of various software programs. For example, the software programs can include application software and printer driver software. The printer driver software controls the image forming apparatus 101 connected with the client devices 102, 103, 104 in which the printer driver software is installed. In certain embodiments, the printer driver software produces a print job and/or document based on an image and/or document data. In addition, the printer driver software can control transmission of the print job from the client device 102, 103, 104 to the image forming apparatus 101.

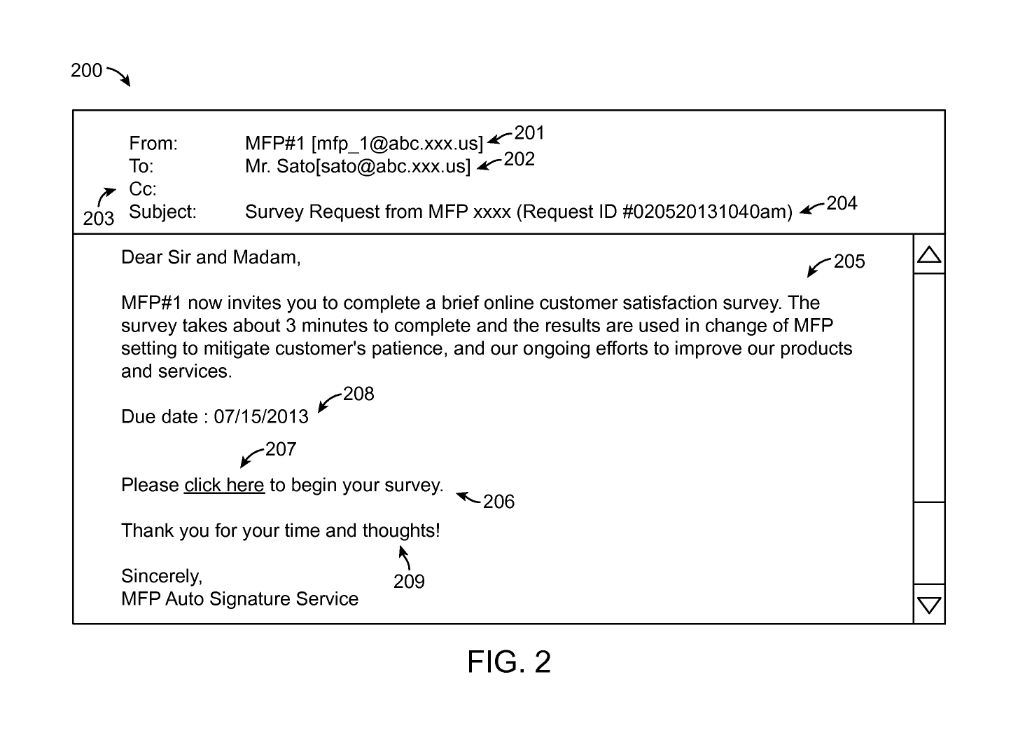

Each of the one or more client devices 102, 103, 104 can also include a display in the form of a graphical user interface. In accordance with an exemplary embodiment, the printer driver software generates a printer driver user interface or graphical user interface in which the user of the one or more client devices 102, 103, 104 can provide instructions to the image forming apparatus 101. In addition, each of the client devices 102, 103, 104 can be configured to receive e-mails 200 (FIG. 2), for example, from the image forming apparatus 101 via the network connection 110, 111 and/or wireless technology including but not limited to radio frequency (RF) and/or infrared (IR) transmission. In accordance with an exemplary embodiment, the users of the client device 102, 103, 104 receive the e-mails 200 generated by the image forming apparatus 101, which can include a customer survey 500 (FIG. 5) requesting information in connection with the performance of the image forming apparatus 101 as disclosed herein. Examples of client devices 102, 103, 104 can include and are not limited to personal computers, routers, image forming apparatuses, and/or personal digital assistants (PDAs).

In accordance with an exemplary embodiment, the image forming apparatus 101 is preferably in the form of an industrial image forming apparatus or multi-functional printer connected to the one or more client devices 102, 103, 104. The one or more client devices 102, 103, 104 can be configured to submit print jobs to the image forming apparatus (printer or printing device) 101 by transmitting data representing the documents to be printed and information describing the print job. The image forming apparatus (for example, printer/printing device) 101 can include a printer controller (or firmware), a memory section preferably in the form of a hard disk drive (HDD), an image processing section (or data dispatcher), a print engine, and an input/output (I/O) section.

The controller of the image forming apparatus 101 can include a central processing unit (CPU), a random access memory (RAM), and a read only memory (ROM). The central processing unit can be configured to execute a sequence of stored instructions (e.g., a computer program). It can be appreciated that the controller also includes an operating system (OS), which acts as an intermediary between the software programs and hardware components within the image forming apparatus 101. The operating system (OS) manages the computer hardware and provides common services for efficient execution of various application software. In accordance with an exemplary embodiment, the controller processes the data and job information received from the one or more client devices 102, 103, 104 to generate a print image.

The image processing section carries out image processing under the control of the controller, and sends the processed print image data to the print engine. The image processing section is preferably capable of processing multiple print jobs or sub-jobs in parallel and independently. For instance, the image processing section can include a CPU that contains multiple cores therein to realize the multiple RIP modules explained in detail later. The CPU used constituting a part of the controller can be commonly used for the image processing section. The print engine forms an image on a recording sheet based on the image data sent from the image processing section. The I/O section performs data transfer with the one or more client devices 102, 103, 104. The controller is programmed to process data and control various other components of the image forming apparatus or printer to carry out the various methods described herein. The hard disk drive (HDD) or storage device stores digital data and/or software programs for recall by the controller. In accordance with an exemplary embodiment, the digital data includes resources, which can include graphics/images, logos, form overlays, fonts, etc.

The input/output (I/O) port provides communications between the printer section and the one or more client devices 102, 103, 104 and receives page descriptions (or print data) from the host for processing within the image forming apparatus 101. In accordance with an exemplary embodiment, the operation of printer section commences when it receives a page description from the one or more client devices 102, 103, 104 via I/O port in the form of a print job data stream. The page description may be any kind of page description languages (PDLs), such as PostScript® (PS), Printer Control Language (PCL), Portable Document Format (PDF), XML Paper Specification (XPS), and so on.

Examples of an image forming apparatus 101 consistent with exemplary embodiments include, but are not limited to, a laser beam printer (LBP), a multifunction peripherals (MFP), a multifunction laser beam printer including copy function, an ink jet printer (IJP), a thermal printer (e.g., a dye sublimation printer) and a silver halide printer. For example, the image forming apparatus can be a color printer or a black and white (B/W) printer.

Examples of the networks 110, 111 consistent with embodiments include, but are not limited to, the Internet, an intranet, a local area network (LAN) and a wide area network (WAN). Alternatively, the Internet or network connection 110, 111, which connects the image forming apparatus 101, the one or more client devices 102, 103, 104, the customer service server 120, and the customer service device 121 can be a wire (or cable) and/or wireless technology including but not limited to radio frequency (RF) and/or infrared (IR) transmission.

In accordance with an exemplary embodiment, each of the customer service server 120 and the customer service device 121 include a processor or central processing unit (CPU), one or more memories for storing software programs and data (such as files to be printed). The processor or CPU carries out the instructions of a computer program, which operates and/or controls at least a portion of the functionality of the customer service server 120 and/or customer service device 121. The customer service server 120 and customer service device 121 can also include an operating system (OS), which manages the computer hardware and provides common services for efficient execution of various software programs.

FIG. 2 is an illustration of a customer survey request in the form of an e-mail (or electronic mail) 200, which is sent from the image forming apparatus 101 to at least one user in accordance with an exemplary embodiment. The customer or user preferably receives the e-mail 200 on a hosted e-mail server, which can be read via an e-mail account on a client device 102, 103, 104. The client device 102, 103, 104 is not limited to personal computers as shown, but can include personal computers and/or personal digital assistants (PDAs). In accordance with an exemplary embodiment, the image forming apparatus 101 preferably hosts within the image forming apparatus 101, the e-mail addresses of user and/or customers. In addition, in accordance with an exemplary embodiment, the image forming apparatus 101 preferably has an e-mail address of each of the users associated with print jobs.

In accordance with an exemplary embodiment, the e-mail 200 can include a sender (e.g., e-mail address of sender) 201, a recipient (e.g., e-mail address of recipient) 202, an optional e-mail address for additional recipients (e.g., “cc”) 203, a subject line 204, and a body or text portion 205 of the e-mail 200. The body or text portion 205 of the e-mail 200 can include a greeting (e.g., “Dear Sir and Madam”) and an invitation or request to the user and/or customer to complete a brief online customer satisfaction survey 206. For example, the body of the e-mail 205 can include a request from the image forming apparatus 101 (or MFP), which reads “MFP #1 now invites you to complete a brief online customer satisfaction survey. The survey takes about 3 minutes to complete and the results are used in change of MFP setting to mitigate customer's patience, and our ongoing efforts to improve our products and services.” The body of the e-mail 205 can also include a due date 208, the request 206, for example, “Please click here to begin survey” having a click through 207 to the customer satisfaction survey, and a closing 209, for example, “Thank you for your time and thoughts!”

In accordance with an exemplary embodiment, the click through 207 preferably connects the user and/or customer on a client device 102, 103, 104 or a personal digital assistant (not shown) to the image forming apparatus 101, which hosts the customer satisfaction survey. It can be appreciated that the customer satisfaction survey can be hosted on the image forming apparatus 101, the customer service server 120 and/or a remote server (not shown). In addition, the e-mail 200 can include a “HELP” link, which can answer questions for the customer and/or user in connection with the customer satisfaction survey and/or provide a link for customers and/or users to be removed from future survey requests.

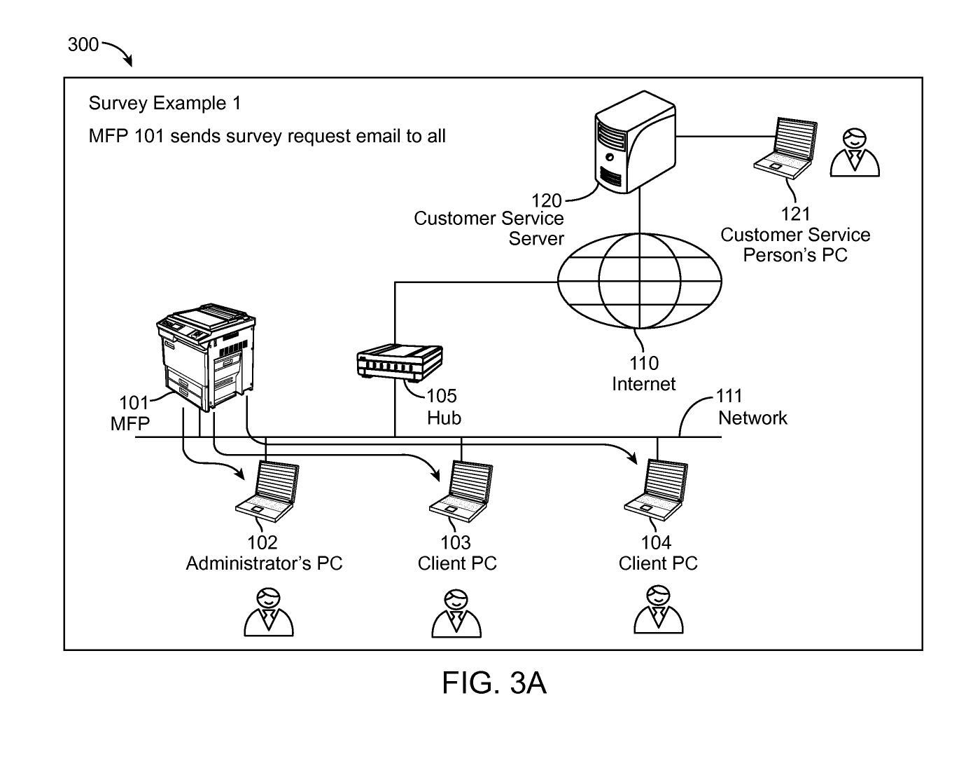

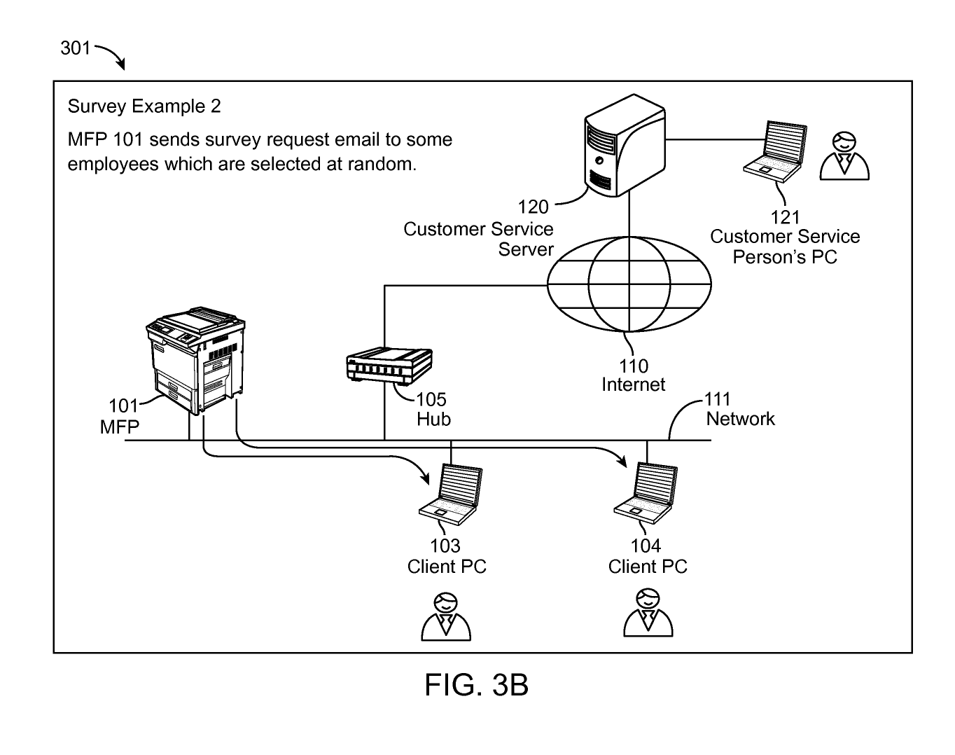

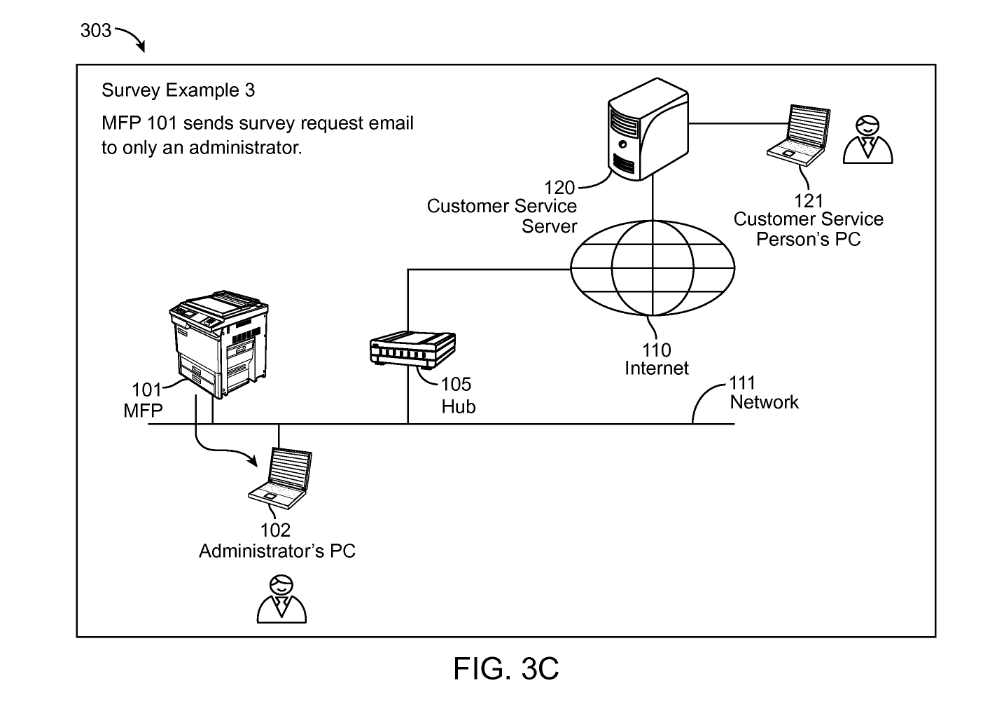

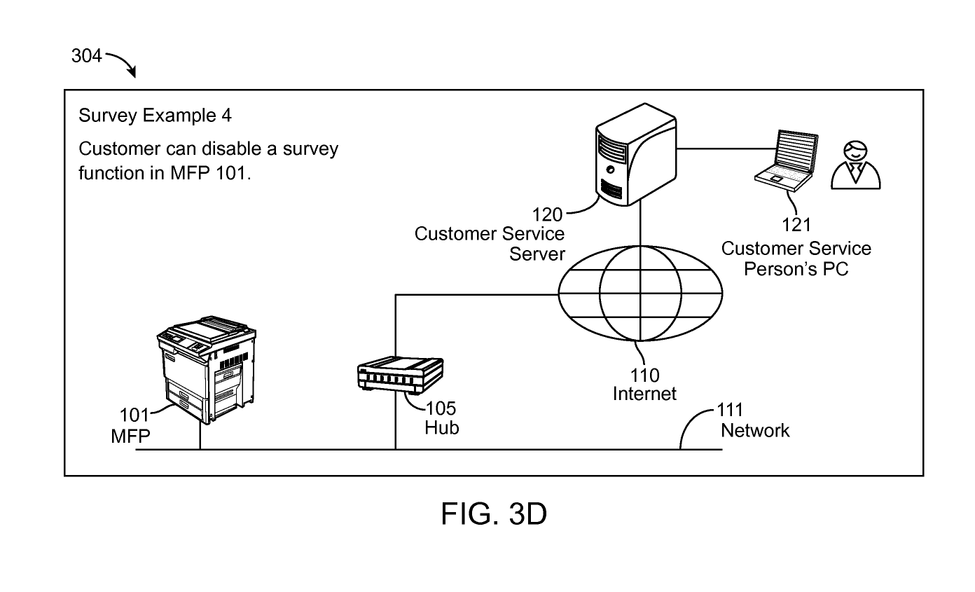

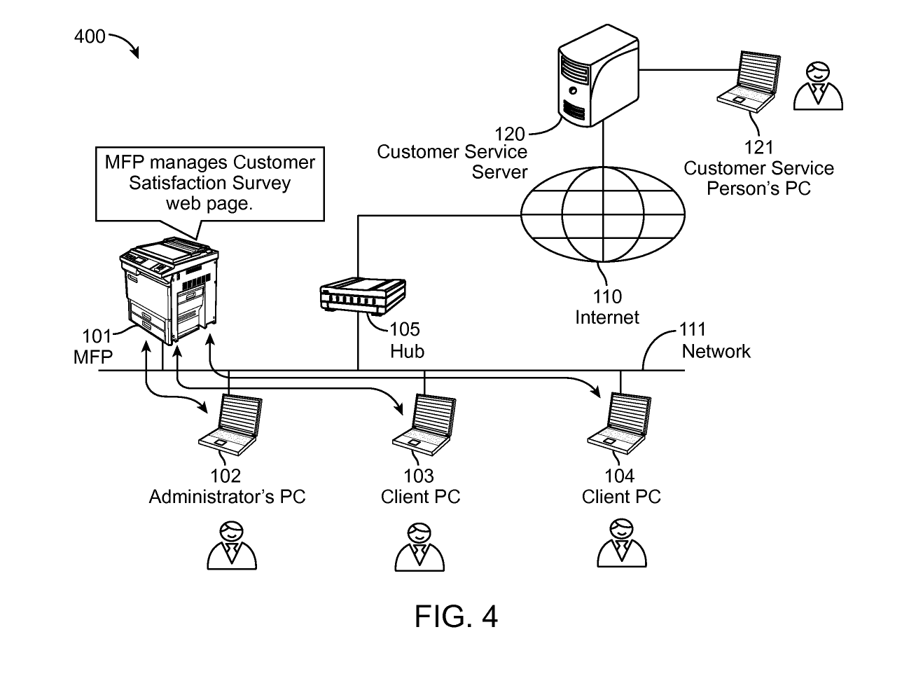

FIGS. 3A-3D are illustrations of different scenarios 300, 301, 302, 304 for an image forming system 100 in connection with generating a customer survey for an image forming apparatus 101. As shown in FIG. 3A, in accordance with an exemplary embodiment, the image forming apparatus 101 can be configured to send a survey request 300 via e-mail 200 to all users and/or customers of the image forming apparatus 101. In FIG. 3B, the image forming apparatus 101 can be configured to send the survey request 301 via e-mail 200 to some and/or portion but less than all of the users (or employees), which for example, can be selected at random. In FIG. 3C, the image forming apparatus 101 sends the survey request 302 via e-mail 200 to only an administrator. In FIG. 3D, the customer and/or the administrator can disable the survey function 304 on the image forming apparatus 101.

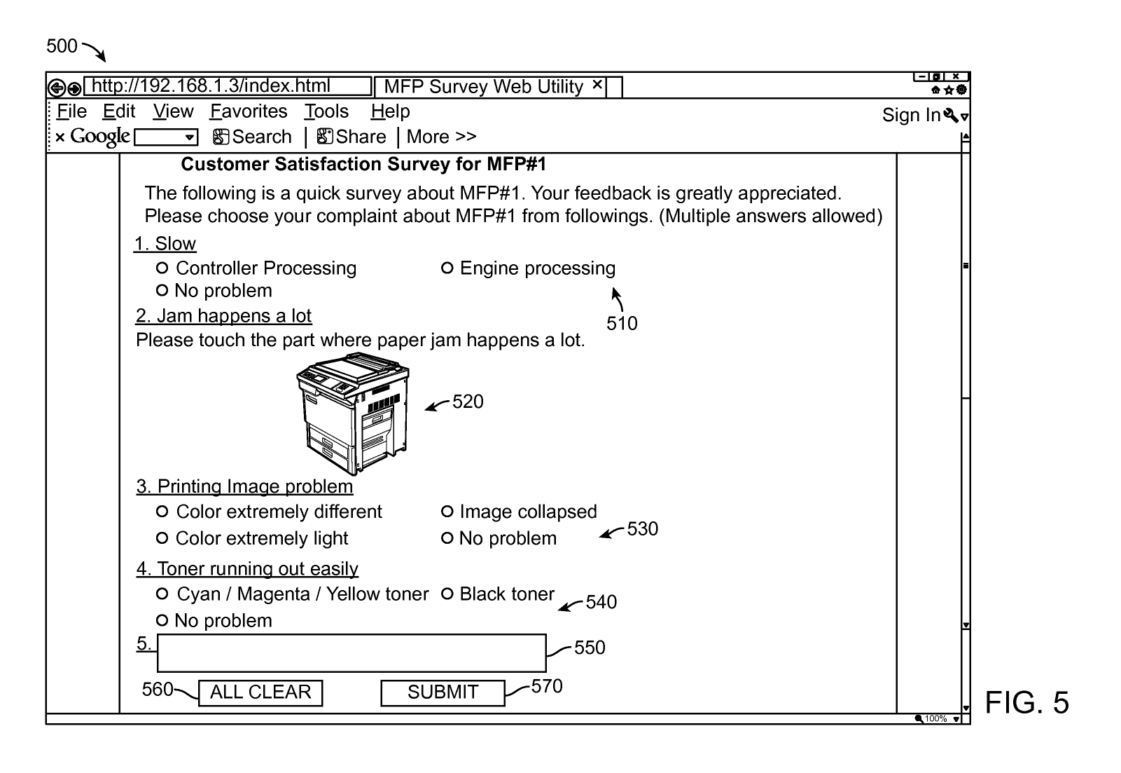

FIG. 4 is an illustration of an image forming system 400 for generating a customer satisfaction survey for an image forming apparatus 101 in accordance with an exemplary embodiment. In accordance with an exemplary embodiment as shown in FIG. 4, the image forming apparatus 101 manages a customer satisfaction survey web page 500 (FIG. 5). The customer satisfaction survey web page 500 can be created and/or hosted by the image forming apparatus 101. Alternatively, the customer satisfaction survey web page 500 can be hosted by the customer service server 120, the customer service device 121, and/or a remoter server (not shown).

FIG. 5 is an illustration of a customer satisfaction survey 500 for an image forming apparatus 101 in accordance with an exemplary embodiment. As shown in FIG. 5, the customer satisfaction survey 500 can include one or more questions, regarding the performance of certain features of the image forming apparatus 101. For example, the customer satisfaction survey 500 can include one or more of the following questions about the performance of the image forming apparatus: “Please choose your complaint about MFP#1 from the following features and/or components: (Multiple answers allowed)”, for example, the features and/or components can include (1) operation of the image forming apparatus is slow, which can be related to controller processing, engine processing, and/or alternatively, no problem 510; (2) paper jams including a touch screen to identifying one or more locations where the paper jams are occurring 520; (3) printing image problems, for example, color extremely different, color extremely light, image collapsed, and/or no problems with the printed images 530; (4) tonner running out easily including cyan/magenta/yellow toner, black toner and/or no problem 540; and (5) other 550. The customer satisfaction survey 500 can also include an “ALL CLEAR” button 560 and/or “SUBMIT” button 570.

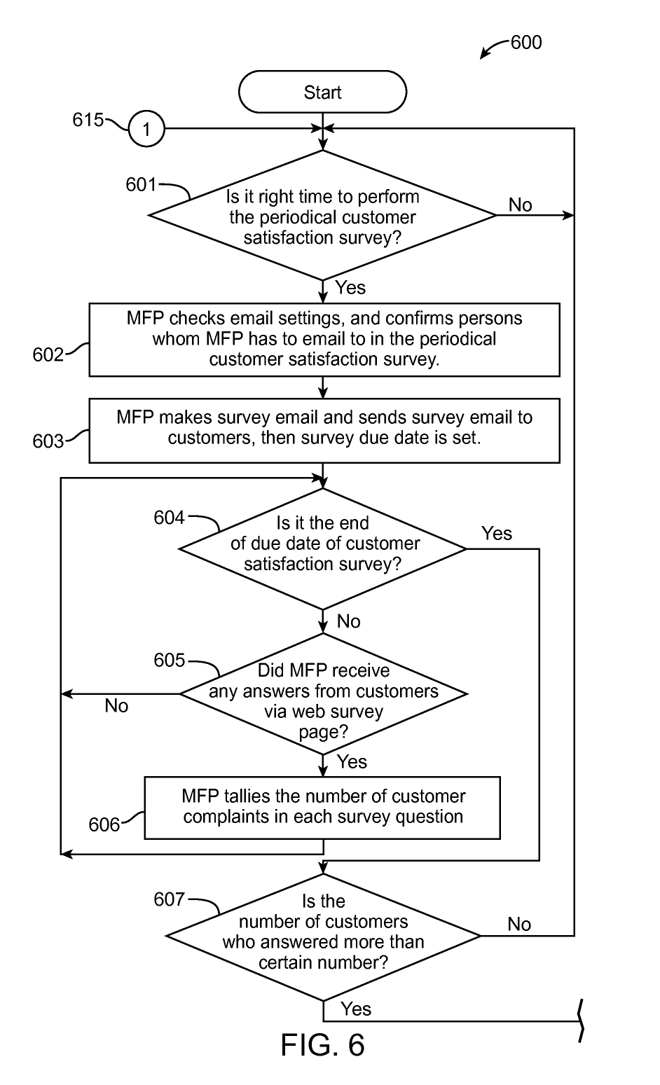

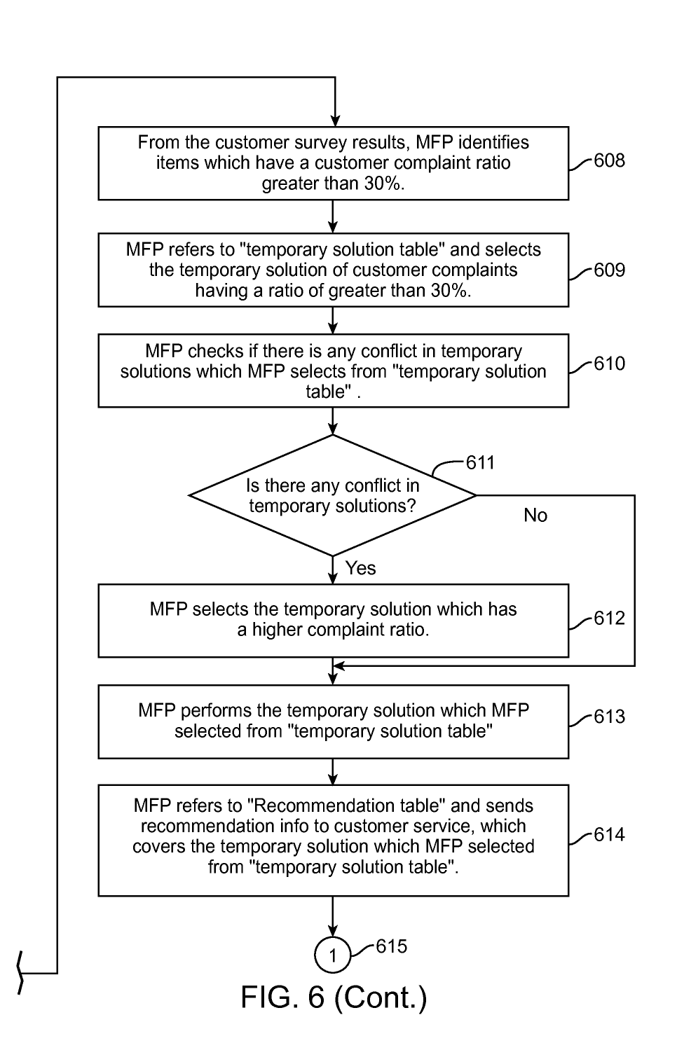

FIG. 6 is a flow chart illustrating a process 600 of sending a customer satisfaction survey 500 from an image forming apparatus 101 to one or more users and/or customers 102, 103, 104 in accordance with an exemplary embodiment. As shown in FIG. 6, in step 601, the image forming apparatus 101 determines if it is time to perform a customer satisfaction survey. In accordance with an exemplary embodiment, the customer satisfaction survey can be sent periodically and/or randomly upon certain events occurring within the image forming apparatus 101. For example, the image forming apparatus 101 can be configured to send the customer satisfaction survey after a certain number of print jobs, a certain number of printed pages, and/or a set time period since the last customer satisfaction survey was sent. If the answer is yes, i.e., it is time to perform and/or conduct the customer satisfaction survey, in step 602, the image forming apparatus 101 checks the e-mail settings, and confirms the identity of each user and/or recipient to whom the image forming apparatus 101 should forward an e-mail with a request to conduct the customer satisfaction survey. If the answer is no, i.e., it is not time to conduct the periodic customer satisfaction survey, the process goes back to step 601 for another determination at a later date and/or time. In step 603, the image forming apparatus generates a customer satisfaction survey e-mail and sends the request in the form of an e-mail to one or more customers and/or users. At the time the survey request is sent, a survey due date can be set by the image forming apparatus 101, which is preferably a date in which answers to the survey are due back to the image forming apparatus 101.

In step 604, a determination is made if the due date has been reached, i.e., “is it the end of the due date of customer satisfaction survey?” If the answer to step 604 is yes, the process continues to step 607, where the image forming apparatus 101 determines, if the number of customers who answered more than a certain number. If the answer to step 604 is no, in step 605, the image forming apparatus determines if the image forming apparatus received any answers from customers via the web survey page. If the answer to step 605 is no, the process returns to step 604. If the answer is yes, in step 606, the image forming apparatus tallies or tabulates the number of customers whose complaints were received in response to each of the survey questions.

In step 607, if the number of customers and/or users who answered the customer survey is greater than a predetermined number, the process continues onward to step 608. If the number of customers and/or users who have answered the customer survey is less than a predetermined number, the process returns to step 601. In step 608, from the customer survey results, the image forming apparatus 101 tabulates based on the survey results (or items), which customer and/or user's complaints have been received in excess of a predetermined number and/or percentage of total complaints and/or a total number of surveys received with and without complaints. For example, in accordance with an exemplary embodiment, any customer and/or user complaints greater than 10%, 15%, 20%, 25%, or 30% can be identified as a customer complaint in which a temporary solution should be applied to the image forming apparatus 101. In accordance with an exemplary embodiment, the temporary solution can mitigate the complaint until a more permanent solution can be implemented on the image forming apparatus 101. In accordance with an exemplary embodiment, for example, if the number of customer complaints exceeds a defined number of complaints, the image forming apparatus 101 can be configured to implement a temporary solution as disclosed herein.

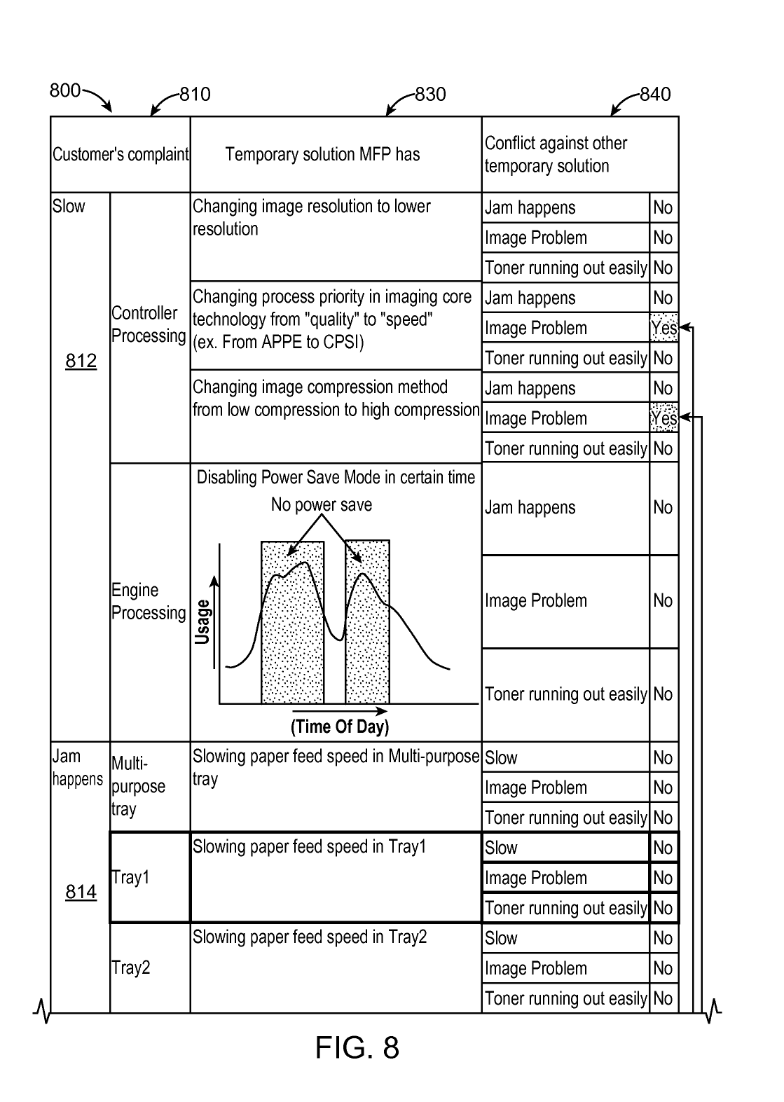

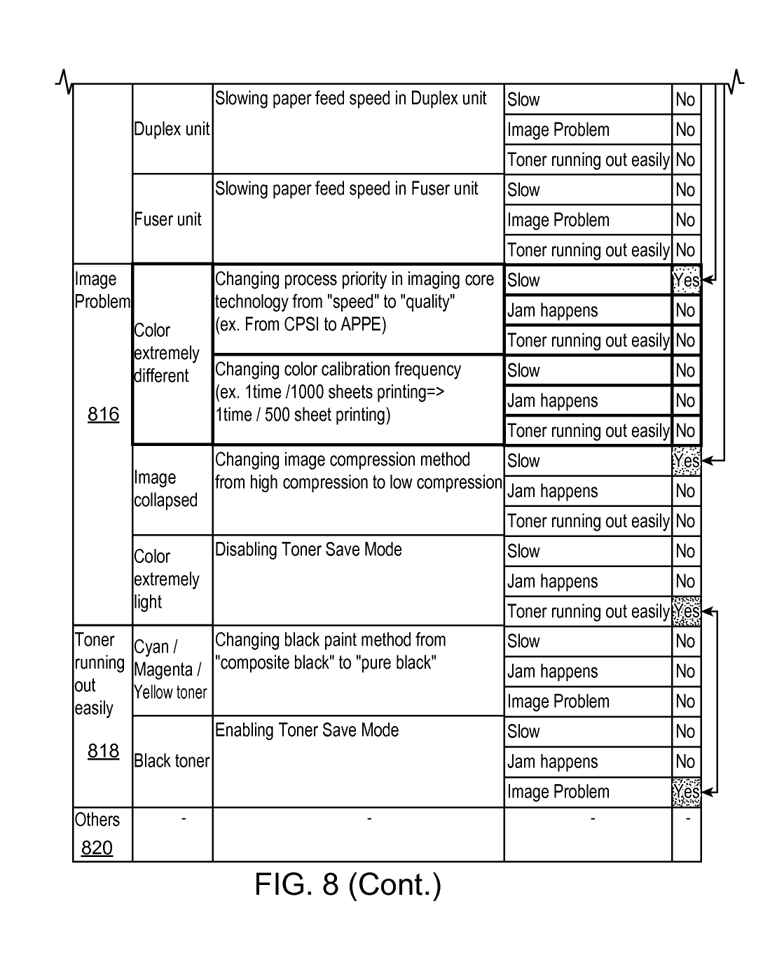

In step 609, the image forming apparatus 101 refers to a “temporary solution table” 830 (FIG. 8), which is hosted on the image forming apparatus 101 and/or on the customer service server 120 for customer complaints in excess of a predetermined number, for example, 30%. The temporary solution table 830 preferably includes one or more temporary solutions for the one or more complaints identified by the answers to the customer satisfaction survey, and image forming apparatus 101 selects the temporary solution to be implemented on the image forming apparatus 101.

In step 610, the image forming apparatus 101, checks to determine if there is any conflicts between the temporary solutions for the customer and/or user complaints, and the process proceeds to step 611. In step 611, the image forming apparatus 101 determines if there are any conflicts between the temporary solutions. If there are no conflicts between the temporary solutions, the process continues to step 613, where the image forming apparatus 101 performs or implements the temporary solution as selected on the image forming apparatus, which the image forming apparatus has chosen from the temporary solution table. If there is a conflict between the temporary solutions, in step 612, the image forming apparatus 101 implements the temporary solution which has the higher complaint ratio.

In step 614, for complaints which temporary solutions have been implemented, the image forming apparatus 101 refers to the “recommendation table” and sends recommendation information to the customer service server 120 and/or customer service provider 121 associated with the image forming apparatus 101. In accordance with an exemplary embodiment, the recommendation information is based on the temporary solution, which was selected by the image forming apparatus 101 from the “temporary solution table”. The recommendation information can be sent upon implementation of any changes to the image forming apparatus 101 based on the customer and/or user's complaints, and/or the recommendation information can be send periodically at set times or intervals. In step 615, the process returns to the start, step 601.

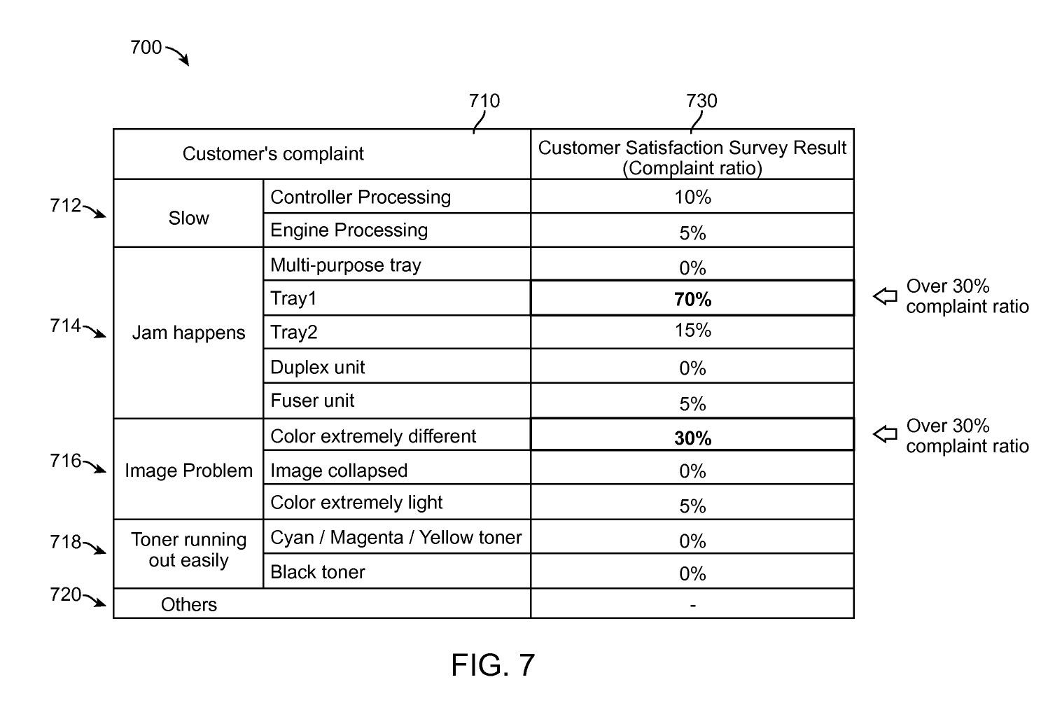

FIG. 7 is a chart 700 illustrating customer and/or user complaints and a corresponding complaint ratio in accordance with an exemplary embodiment. As shown in FIG. 7, the customer complaints 710 can include: slowness associated with processing of print jobs associated with the image forming apparatus 712, paper jams (i.e., “jam happens”) 714, image problems 716, toner running out easily 718, and other (i.e., other problems) 720. For example, the slowness of the image forming apparatus 101 can include problems associated with controller or processing speed associated with the processing of the print jobs and/or engine processing, for example, delays in the print engine becoming operational, for example, slowness in reaching an operational status, for example, from a sleep mode.

In accordance with an exemplary embodiment, jamming of the image forming apparatus (i.e., “jam happens”) 714 can include paper jams occurring within and/or associated with a multi-purpose tray, tray 1, tray 2, a duplex unit, and/or a fuser unit.

In accordance with an exemplary embodiment, the image problems 716 can include color extremely different, image collapsed, and/or color extremely light. For example, the toner running out easily can include cyan/magenta/yellow toner and/or black toner. In accordance with an exemplary embodiment, the customer satisfaction survey results (and/or complaint ratios) 730 can be expressed as a percentage of total complaints.

FIG. 8 is a chart 800 illustrating customer and/or user complaints 810, a temporary solution table 830 for the image forming apparatus, and conflicts against other temporary solutions 840 of the image forming apparatus in accordance with an exemplary embodiment. As shown in FIG. 8, the chart 800 includes customer and/or user's complaints 810, a table of temporary solutions 830, and a listing conflicts against other solutions 840 within the image forming apparatus. For example, for customer's complaints 810 for the image forming apparatus 101, which complain that the image forming apparatus 101 is running slow 812, the solutions related to the controller processing and engine processing can include changing image resolution to a lower resolution, changing process priority in image core technology from “quality” to “speed” (for example, from APPE to CPSI), and/or changing and/or disabling power save mode at a certain time.

In accordance with an exemplary embodiment, paper jams (or “jam happens”) 814, for example, can occur within the multi-purpose tray, tray 1, tray 2, the duplex unit, and/or the fuser unit. In accordance with an exemplary embodiment, solutions to paper jams can include slowing the paper feed speed, for example, in the multi-purpose tray, slowing the paper feed speed in tray 1, slowing the paper feed in tray 2, slowing the paper feed speed in the duplex unit and/or slowing the paper feed speed in the fuser unit.

The image problems 816 can include extremely different colors, images which are collapsed, and/or color extremely light colors on printed images and/or printed documents. In accordance with an exemplary embodiment, solutions can include changing process priority in image core technology from “speed” to “quality”, for example, from CPSI to APPE; and/or changing color calibration frequency, for example, from 1 time per each 1000 sheets printed to 1 time per each 500 sheets printed; changing image compression method from high compression to low compression; and/or disabling a toner save mode.

In accordance with an exemplary embodiment, for example, for the toner running out easily 818, the solutions can include changing black paint method from “composite black” to “pure black”; and/or enabling a toner save mode. In addition, the customer complaints 810 can include “others” 820, which are not identified in the list of complaints as identified on the customer satisfaction survey.

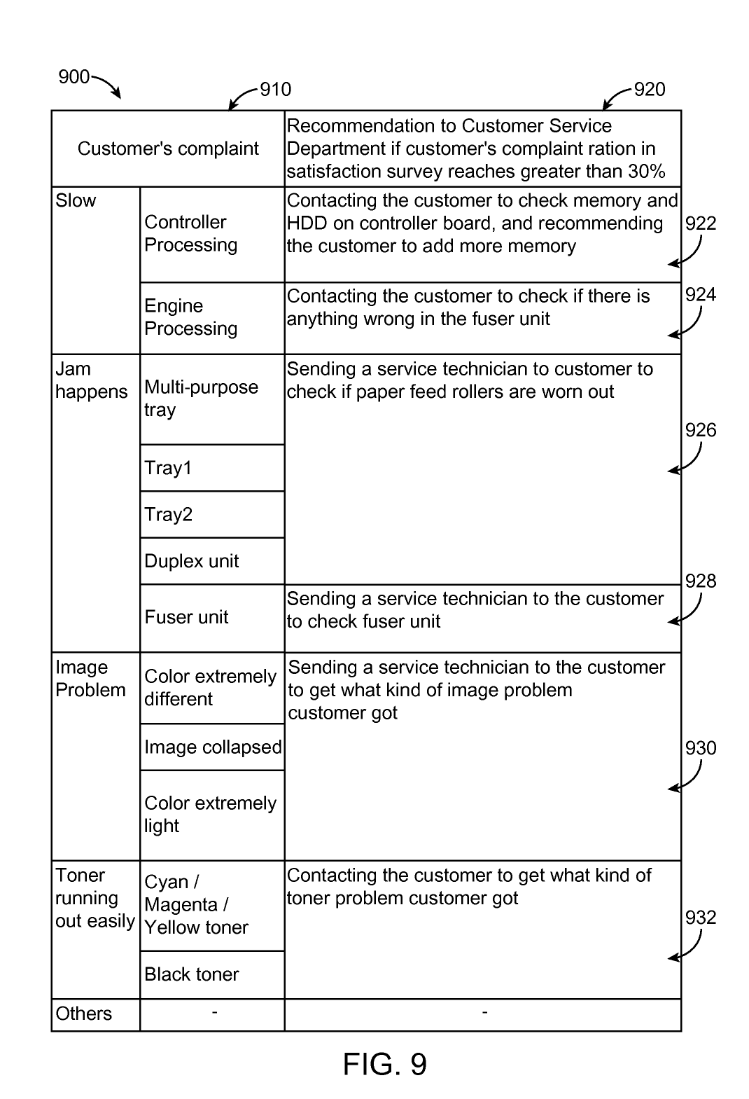

FIG. 9 is a chart 900 illustrating customer and/or user complaints 910 and recommendations to a customer service department, if customer complaint ratio exceeds a predetermined ratio 920 in accordance with an exemplary embodiment. In accordance with an exemplary embodiment, the customer service department is associated with the image forming apparatus and/or a vendor contracted to provide service to the image forming apparatus 101. In accordance with an exemplary embodiment, for example, if the customer complaint ratio exceeds a predetermined ratio, the recommendations 920 can include: (1) contacting the customer to check memory and HDD on controller board, and recommending the customer to add more memory 922; (2) contacting the customer to check if there is anything wrong in the fuser unit 924; (3) sending a service technician to the customer to check if paper feed rollers are worn out 926; (4) sending a service technician to the customer to check the fuser unit 928; (5) sending a service technician to the customer to determine the type or kind of image problems 930; and/or (6) contacting the customer to obtain what kind of toner problem the user is experiencing 932.

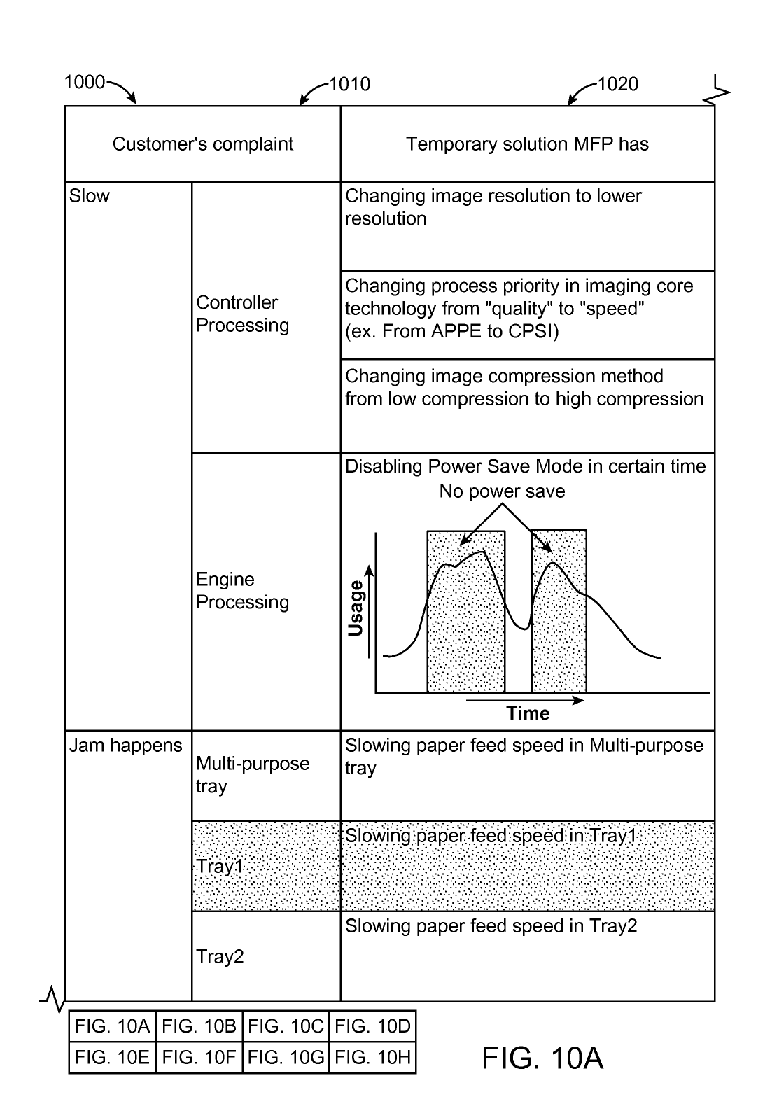

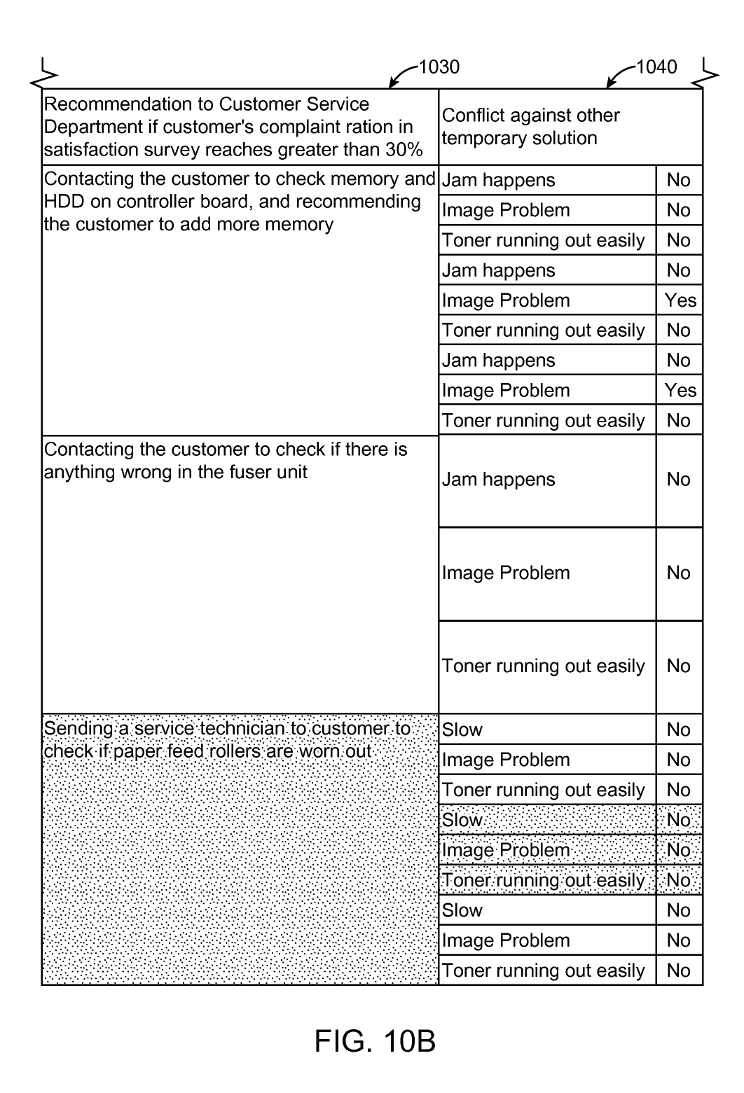

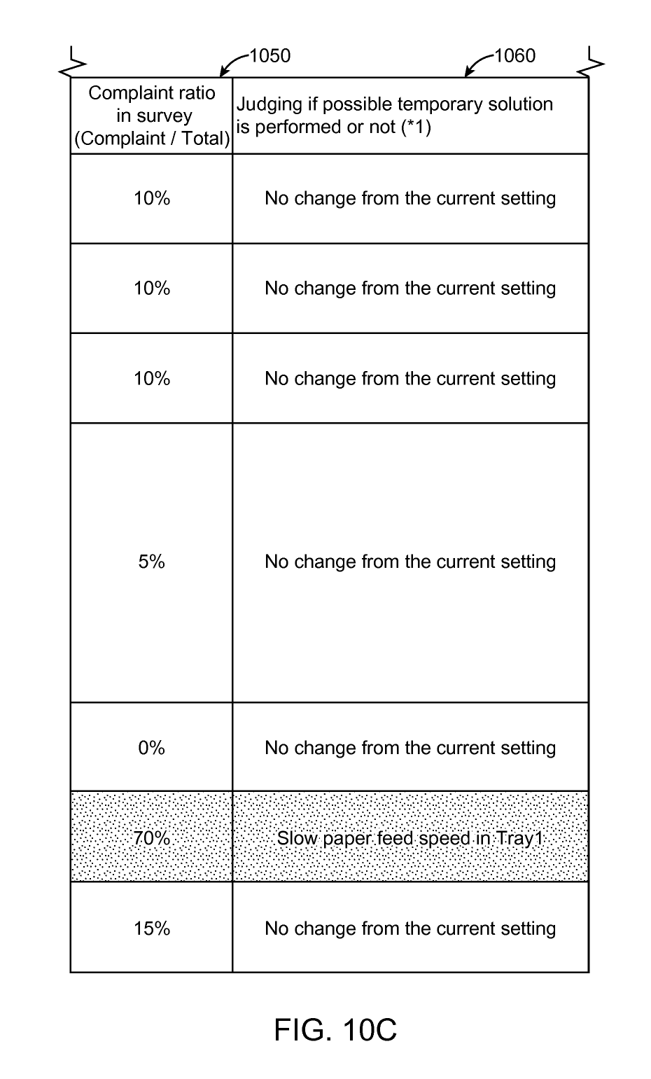

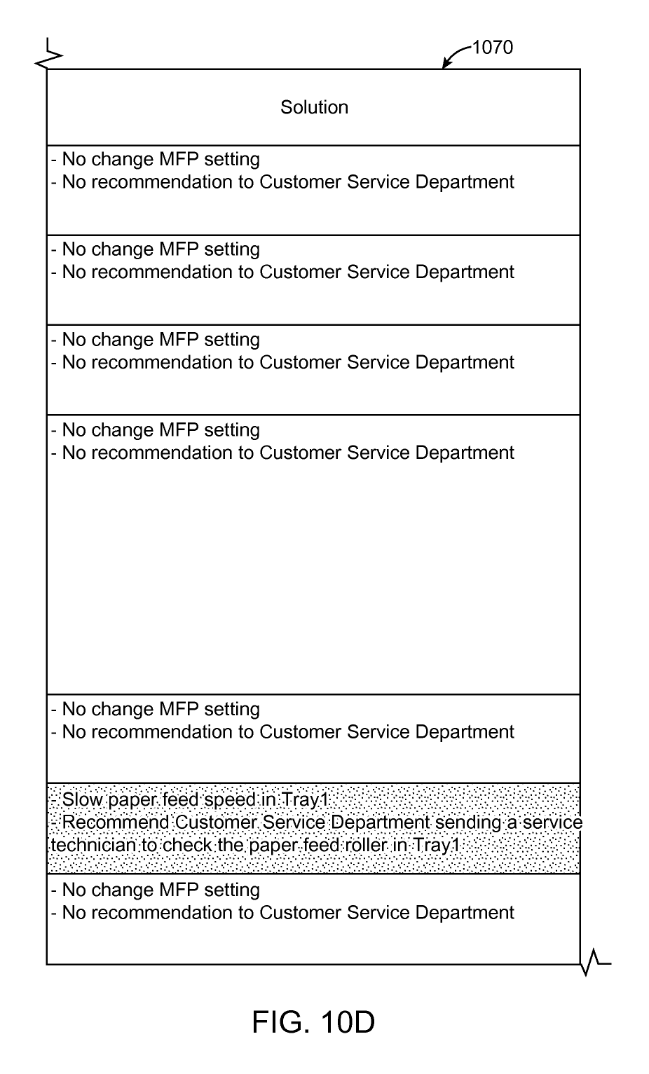

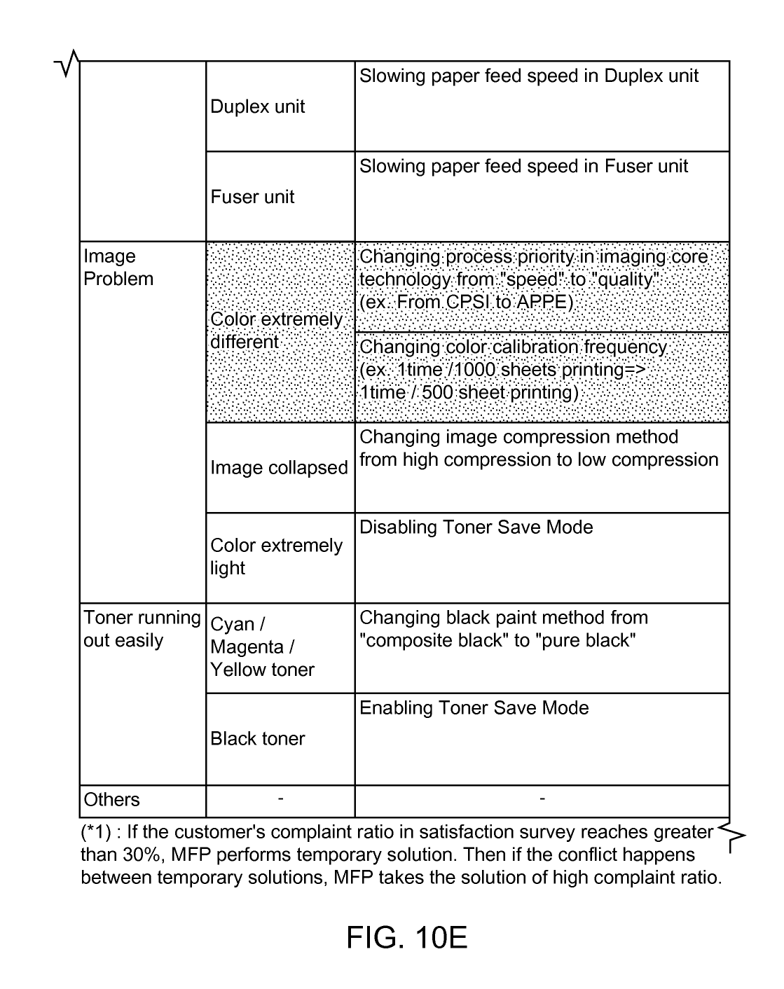

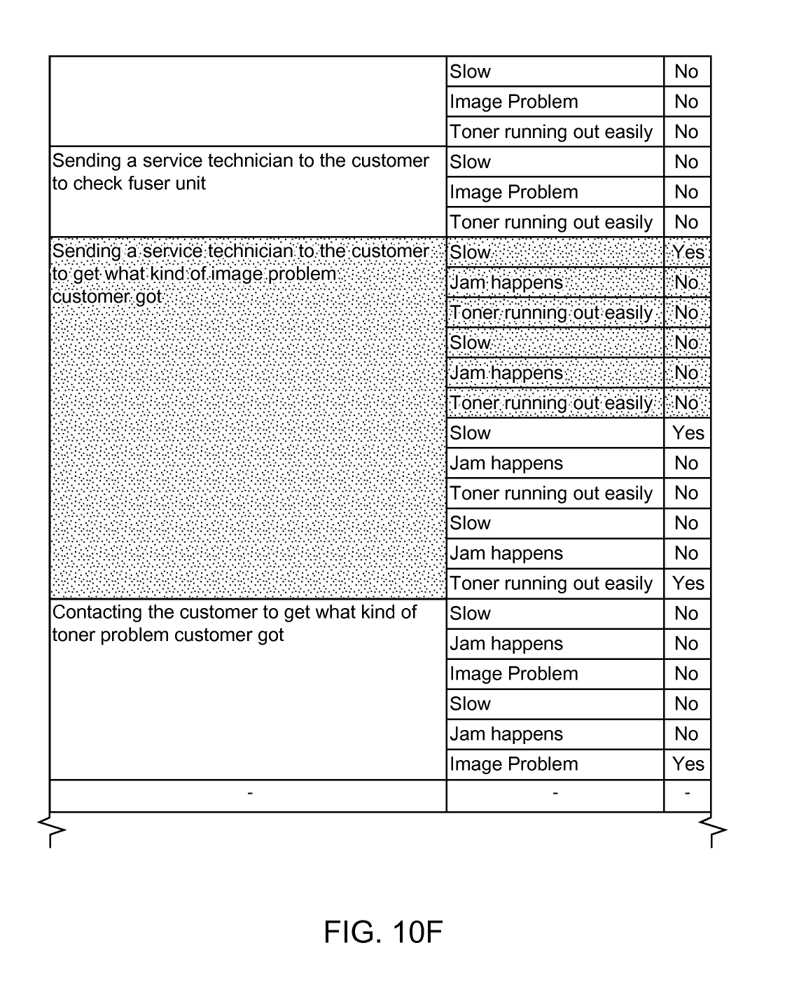

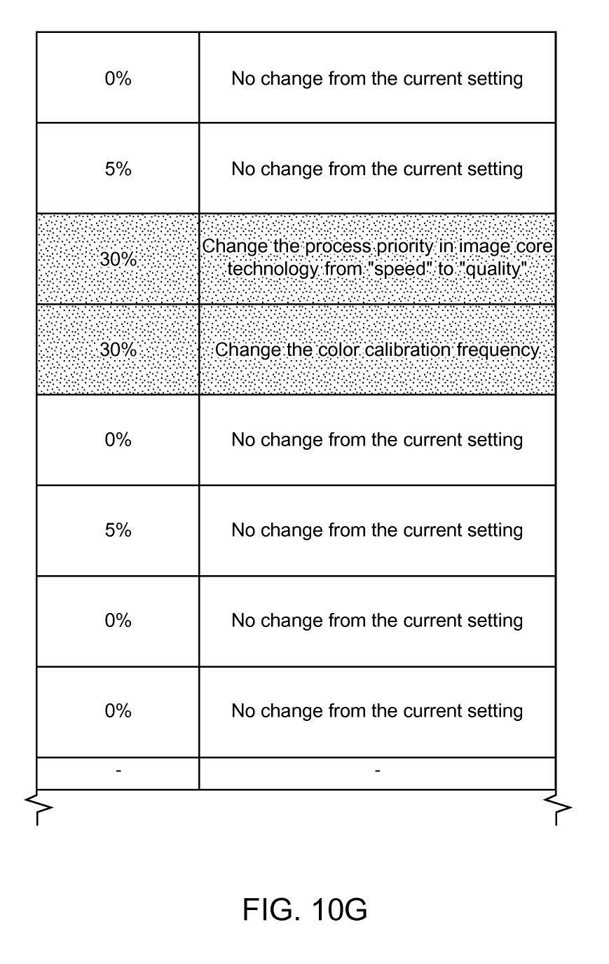

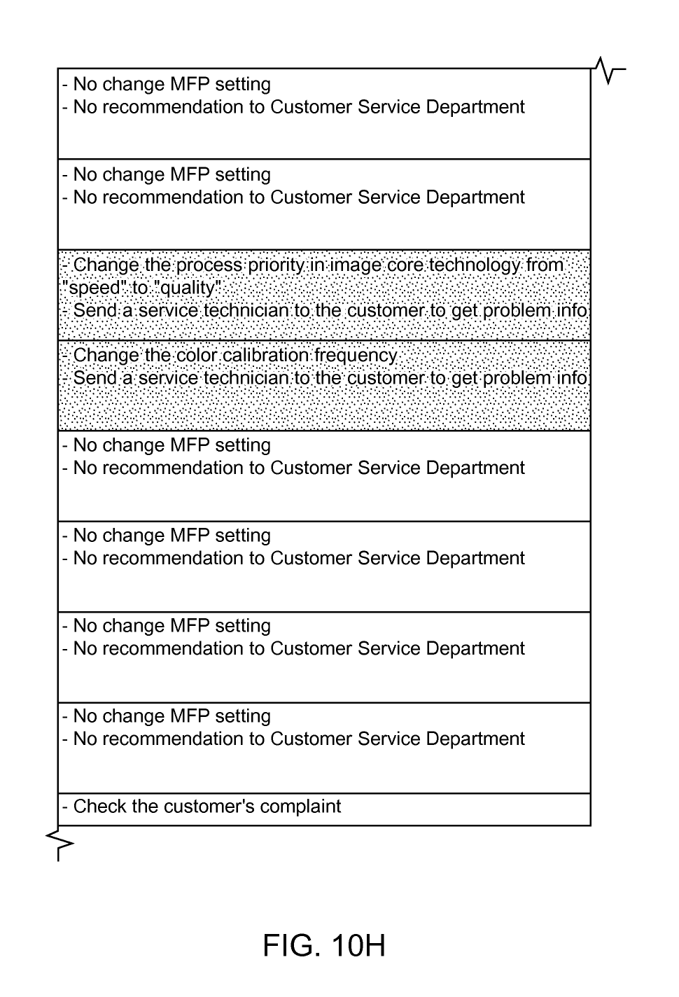

FIG. 10 is an illustration of a chart 1000 showing customer complaints 1010, temporary solutions provided by the image forming apparatus 1020, recommendations to a customer service department 1030, conflicts against other temporary solutions of the image forming apparatus 1040, complaint ratio 1050, determination if a temporary solution is performed or not 1060, and solutions 1070 in accordance with an exemplary embodiment. As shown in FIG. 10, the image forming apparatus 101 judges if the temporary solution should be performed (or not) 1060, for example, complaint ratio greater than 30%, and a corresponding solution 1070.

In accordance with an exemplary embodiment, a computer program product comprising a non-transitory computer readable medium having a computer readable code embodied therein for generating a customer survey for an image forming apparatus, the computer readable program code configured to execute a process, which includes the steps of: generating an e-mail on the image forming apparatus addressed to one or more customers, each of the one or more customers having sent at least one print job to the image forming apparatus; forwarding the generated e-mail to the one or more customers, wherein each of the one or more customers is requested to complete a customer satisfaction survey; receiving answers to the customer satisfaction survey from the one or more customers; tabulating the answers to the customer satisfaction survey from the one or more customers to determine if the image forming apparatus has one or more complaints associated therewith; selecting a temporary solution for each of the one or more complaints on the image forming apparatus having a complaint ratio greater than a predetermined ratio; and implementing a temporary solution on the image forming apparatus for each of the one or more complaints on the image forming apparatus having the complaint ratio greater than the predetermined ratio.

The non-transitory computer usable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for generating a customer survey for an image forming apparatus, comprising:
generating an e-mail on the image forming apparatus addressed to one or more customers, each of the one or more customers having sent at least one print job to the image forming apparatus;
forwarding the generated e-mail to the one or more customers, wherein each of the one or more customers is requested to complete a customer satisfaction survey;
receiving answers to the customer satisfaction survey from the one or more customers;
tabulating the answers to the customer satisfaction survey from the one or more customers to determine if the image forming apparatus has one or more complaints associated therewith;
selecting a temporary solution for each of the one or more complaints on the image forming apparatus having a complaint ratio greater than a predetermined ratio; and
implementing the temporary solution on the image forming apparatus for each of the one or more complaints on the image forming apparatus having the complaint ratio greater than the predetermined ratio.

2. The method of claim 1, comprising:
determining if a conflict exists between the temporary solutions for each of the one or more complaints on the image forming apparatus; and
if more than one temporary solution exists for each of the one or more complaints, selecting the temporary solution having a higher complaint ratio.

3. The method of claim 1, comprising:
setting a due date for a completion of the customer satisfaction survey, and upon reaching the due date from the customer satisfaction survey;
determining if a number of responses to the customer satisfaction survey exceeded a predetermined number for a period set by the image forming apparatus based on the due date; and
calculating the ratio of complaints for each of the one or more complaints of the image forming apparatus having a complaint associated therewith.

4. The method of claim 1, comprising:
sending the results of the customer satisfaction survey to a customer service representative, wherein the results of customer satisfaction survey includes a recommendation.

5. The method of claim 1, comprising
periodically sending the customer satisfaction survey to the one or more customers.

6. The method of claim 1, comprising:
randomly selecting one or more customers to receive the customer satisfaction survey from a group of users of the image forming apparatus.

7. The method of claim 1, wherein the e-mail includes a click through to the customer satisfaction survey.

8. The method of claim 7, comprising:
hosting the customer satisfaction survey on the image forming apparatus.

9. The method of claim 1, comprising:
hosting e-mail addresses for the one or more customers on the image forming apparatus.

10. A computer program product comprising a non-transitory computer readable medium having a computer readable code embodied therein for generating a customer survey for an image forming apparatus, the computer readable program code configured to execute a process, which includes the steps of:
generating an e-mail on the image forming apparatus addressed to one or more customers, each of the one or more customers having sent at least one print job to the image forming apparatus;
forwarding the generated e-mail to the one or more customers, wherein each of the one or more customers is requested to complete a customer satisfaction survey;
receiving answers to the customer satisfaction survey from the one or more customers;
tabulating the answers to the customer satisfaction survey from the one or more customers to determine if the image forming apparatus has one or more complaints associated therewith;
selecting a temporary solution for each of the one or more complaints on the image forming apparatus having a complaint ratio greater than a predetermined ratio; and
implementing the temporary solution on the image forming apparatus for each of the one or more complaints on the image forming apparatus having the complaint ratio greater than the predetermined ratio.

11. The computer program product of claim 10, comprising:
determining if a conflict exists between the temporary solutions for each of the one or more complaints on the image forming apparatus; and
if more than one temporary solution exists for each of the one or more complaints, selecting the temporary solution having a higher complaint ratio.

12. The computer program product of claim 10, comprising:
setting a due date for a completion of the customer satisfaction survey, and upon reaching the due date from the customer satisfaction survey;
determining if a number of responses to the customer satisfaction survey exceeded a predetermined number for a period set by the image forming apparatus based on the due date; and
calculating the ratio of complaints for each of the one or more complaints of the image forming apparatus having a complaint associated therewith.

13. The computer program product of claim 10, comprising:
sending the results of the customer satisfaction survey to a customer service representative, wherein the results of customer satisfaction survey includes a recommendation.

14. The computer program product of claim 10, comprising:
hosting the customer satisfaction survey on the image forming apparatus;
periodically sending the customer satisfaction survey to the one or more customers, and
randomly selecting one or more customers to receive the customer satisfaction survey from a group of users of the image forming apparatus.

15. The computer program product of claim 10, wherein the e-mail includes a click through to the customer satisfaction survey.

16. An image forming system comprising:
one or more client devices, which are operable by one or more customers; and
an image forming apparatus connected to the one or more client devices, wherein the image forming apparatus perform the following steps:
generating an e-mail on the image forming apparatus addressed to the one or more customers, each of the one or more customers having sent at least one print job to the image forming apparatus;
forwarding the generated e-mail to the one or more customers, wherein each of the one or more customers is requested to complete a customer satisfaction survey;
receiving answers to the customer satisfaction survey from the one or more customers;
tabulating the answers to the customer satisfaction survey from the one or more customers to determine if the image forming apparatus has one or more complaints associated therewith;
selecting a temporary solution for each of the one or more complaints on the image forming apparatus having a complaint ratio greater than a predetermined ratio; and
implementing the temporary solution on the image forming apparatus for each of the one or more complaints on the image forming apparatus having the complaint ratio greater than the predetermined ratio.

17. The system of claim 16, wherein the image forming apparatus performs the following steps:
determining if a conflict exists between the temporary solutions for each of the one or more complaints on the image forming apparatus; and
if more than one temporary solution exists for each of the one or more complaints, selecting the temporary solution having a higher complaint ratio.

18. The system of claim 16, wherein the image forming apparatus performs the following steps:
setting a due date for a completion of the customer satisfaction survey, and upon reaching the due date from the customer satisfaction survey;
determining if a number of responses to the customer satisfaction survey exceeded a predetermined number for a period set by the image forming apparatus based on the due date; and
calculating the ratio of complaints for each of the one or more complaints of the image forming apparatus having a complaint associated therewith.

19. The system of claim 16, wherein the image forming apparatus performs the following steps:
sending the results of the customer satisfaction survey to a customer service representative, wherein the results of customer satisfaction survey includes a recommendation.

20. The system of claim 16, wherein the image forming apparatus performs the following steps:
hosting the customer satisfaction survey on the image forming apparatus;
periodically sending the customer satisfaction survey to the one or more customers, and
randomly selecting one or more customers to receive the customer satisfaction survey from a group of users of the image forming apparatus.
